(19) United States
(12) Patent Application Publication
(10) Pub. No.: US 2004/0025520 A1
(43) Pub. Date: Feb. 12, 2004

(54) Cryogenic fluid transfer and storage

(76) Inventor: Mark J Robbie, West Lothian (GB)

Correspondence Address: Carol A Lewis White, W L Gore & Associates Inc, 551 Paper Mill Road, Newark, DE, 19714-9206, US

(21) Appl. No.: 10/276,101

(22) PCT Filed: May 14, 2001
(86) PCT No.: PCT/GB01/02086

(30) Foreign Application Priority Data
May 13, 2000 (GB) 0011452.0

(51) Int. Cl. F17C 13/00; F16L 9/18; F16L 11/00

(52) U.S. Cl. 62/50.7; 138/114; 138/137

(57) ABSTRACT

A method of transferring a cryogenic fluid comprises passing a cryogenic fluid through a flexible conduit having a wall formed of a first layer of a porous polymeric (12) material and a second layer formed of an impermeable material (14).

### FIELD OF THE INVENTION

This invention relates to methods of transferring and storing cryogenic fluids, and in particular to the use of flexible conduits and containers for transfer and storage of such fluids.

### BACKGROUND OF THE INVENTION

Vacuum and dry gas insulated tubes are typically used to transport or store cold liquids or liquids with a low heat of vaporisation. The coaxial design of these transfer tubes reduces the warming rate of the cold liquid and results in a reduced exterior temperature. The transfer tubes usually consist of two straight, corrugated or convoluted stainless steel tubes mounted one over top of the other. The use of multiple tubes provides some degree of insulation to help maintain low temperature liquids in a liquid state. The use of corrugations or convolutions lends somewhat increased flexibility, that is a reduced bending radius, to the construction. A protective stainless steel mesh is often applied to the outer surface of the transfer tube. Overall, these transfer tubes suffer from numerous problems, including poor bend radius, excessive weight and size, and prolonged time to deliver cold liquids due to the initial cooling of the tubing by the liquid which is necessary before the liquid may pass through the tubing without significant vaporisation.

Alternative tubes in the prior art are much like the tubes described above except that they do not provide a coaxial insulating space. Consequently, they do not provide the same insulating benefits. These tubes are typically used to deliver cold liquids over relatively short distances, such as delivering liquids from a storage tank. These transfer tubes also suffer from a poor bend radius, large mass, prolonged time to deliver cold liquids and excessive frost accumulation on the outer surface of the tube and subsequent pooling of water in the vicinity after thawing. The tubes may also become brittle in use, and if used to carry cryogenic fluids under pressure there may be a risk that a tube may rupture, the resulting fragments of material and pressurised leaking fluid presenting a hazard to operators in the vicinity.

U.S. Pat. No. 4,745,760 to Porter (NCR Corporation) discloses a cryogenic fluid transfer conduit. The conduit transfers the fluid through an impermeable tube from a cryogenic reservoir to an enclosure for cooling an integrated circuit, and its coaxial channel is used to return the fluid to the reservoir. This apparatus relies on the fluid delivered out of the end of the tube to be re-directed into the coaxial space for improved insulative properties.

A closed ended surgical cryoprobe instrument is described in U.S. Pat. No. 5,520,682 to Baust et al. This patent teaches the use of a closed system to chill the end portion of a surgical instrument. An impermeable inner tube is provided to deliver cooling fluid, with no fluid delivered outside of the chambers of the device.

U.S. Pat. No. 4,924,679 to Brigham et al. describes an insulated cryogenic hose. A fluid that liquefies or solidifies at cryogenic temperatures fills the coaxial space of the article of this invention to improve insulation, but at the cost of loss of overall flexibility of the tube.

Various polymers are known to be useful under low temperature conditions such as 77° Kelvin (the temperature at which Nitrogen will remain liquid at atmospheric pressure). For example, porous polytetrafluoroethylene (PTFE) is known to retain strength and flexibility at low temperatures, particularly in the form of porous expanded PTFE (ePTFE) constituted by nodes interconnected by fibrils as described in U.S. Pat. No. 3,953,566 to Gore. Such ePTFE, however, is not normally suitable for the transport or storage of cryogenic liquids because of its porosity, which allows cryogenic liquids to have ready passage into and through the ePTFE material.

Temperature gradients affecting materials used in systems such as those involving cryogens are such that thermal expansion and contraction effects may cause early mechanical failure in components. Preferred embodiments of this invention relate to materials that retain flexibility and strength at low temperatures, particularly cryogenic temperatures, such as 77 Kelvin.

### SUMMARY OF THE INVENTION

The various aspects of the invention take advantage of the advantageous properties of porous polymeric materials, particularly porous polytetrafluoroethylene (PTFE).

One embodiment of the present invention relates to a method of transferring a cryogenic fluid, the method comprising passing a cryogenic fluid through a flexible conduit having a wall formed of a first layer of a porous polymeric material and a second layer formed of an impermeable material.

It has been found that this method compares favourably with conventional methods of transferring cryogenic fluids. As described below, the use of a porous polymeric material to form at least a portion of the wall of the conduit has numerous surprising benefits, including relatively low mass, increased flexibility, and improved insulation. The use of the preferred fluoropolymers also enables the design of more flexible tubes that can also withstand more flexural stresses prior to failure.

The impermeable material may be selected from a wide range of flexible materials having appropriate low temperature characteristics, including polymeric materials, such as ethylene-polypropylene copolymer (EPC), polyester-based materials, polyvinylchloride (PVC), and fluoropolymers such as PTFE, fluorinated ethylene propylene (FEP), perfluoroalkoxy polymer (PFA) and blends and composites thereof.

Preferably, the porous polymeric material is a porous fluoropolymer, and porous expanded PTFE (ePTFE) is a particularly preferred material because of its flexibility at cryogenic temperatures.

Preferably, the first layer is selected to have a heat capacity of less than 2.251×10⁶ kJ/m³K. The relatively low heat capacity results in the first layer being cooled more rapidly to cryogenic temperatures on flow of fluid through the conduit being initiated. As a result, there is less production of gaseous cryogenic fluid on the fluid first encountering the relatively warm conduit, and flow of fluid through the conduit may commence more rapidly. The preferred expanded PTFE has a relatively low heat capacity, determined by its density, and is less than 2.251×10⁶ kJ/m³K, the heat capacity of unexpanded PTFE.

According to another aspect of the invention, there is provided a method of transferring a cryogenic fluid between two relatively movable locations, the method comprising passing a cryogenic fluid through a flexible conduit having a wall formed of a first layer of a porous polymeric material and a second layer formed of an impermeable material.

The ability of the present invention to transfer cryogenic fluid through a flexible conduit, facilitates the transfer of cryogenic fluid between two relatively movable locations, such as supplying cryogenic fluid from a cryogenic fluid source to a vibrating machine or a machine having a moving tool head or movable robot arm.

According to a further aspect of the invention, there is provided a method of storing a cryogenic fluid, the method comprising placing a cryogenic fluid in a container having a wall formed of a first layer of a porous polymeric material and a second layer formed of an impermeable material.

As with the fluid transfer aspects of the invention described above, the invention offers numerous advantages in the storage of cryogenic fluids, including the ability to store and transport cryogenic fluids in flexible containers.

The invention also relates to a method of insulating a cryogenic fluid container having a wall formed of a first layer of an impermeable material, the method comprising providing the wall with a second layer of a porous polymeric material.

While the impermeable layer provides for containment of the cryogenic fluid, the porous polymeric material may provide effective insulation and structural strength, without detracting from desirable physical and structural attributes, such as flexibility and low mass.

The second layer of porous polymeric material may be provided either internally or externally of the first layer, and indeed in some embodiments may be provided both internally and externally.

Another aspect of the invention relates to a flexible cryogenic fluid transfer conduit comprising a wall formed of a first portion of a porous polymeric material and a second portion comprising a plurality of layers of coiled impermeable sheet.

A further aspect of the present invention provides a flexible cryogenic fluid transfer conduit comprising a wall formed of a inner first portion comprising a plurality of layers of porous polymeric sheet and an outer second portion comprising a plurality of layers of impermeable sheet, the impermeable sheet being of smaller thickness than the porous polymeric sheet.

Impermeable material tends to be relatively inflexible, particularly at cryogenic temperatures, and thus the layers of impermeable sheet are of relatively small thickness, to preserve as much flexibility as possible. Also, the impermeable material may be spaced from direct contact with the cryogenic liquid by the inner first portion of porous material, and thus may not experience the same extreme low temperatures that the porous material experiences. The invention also facilitates such a construction, as many of the physical and structural attributes of the conduit may be provided by the relatively flexible porous material, the main function of the impermeable material simply being to contain the fluid.

A still further aspect of the present invention relates to a flexible cryogenic fluid transfer conduit comprising a wall formed of a first portion of porous polymeric material and a second portion of impermeable material, the conduit having a diameter of less than 25.4 mm.

In another aspect of the present invention there is provided a flexible cryogenic fluid transfer conduit comprising a wall formed of a first portion of a seamless porous polymeric tube and a second portion of impermeable material.

The seamless porous polymeric tube, typically formed by extruding material in tube form, provides a convenient base tube for the conduit.

One aspect of the present invention relates to a flexible cryogenic fluid transfer conduit comprising a wall formed of a first portion of porous polymeric material and a second portion of impermeable material, at cryogenic temperatures the conduit having a flexibility, as determined by the bend diameter test set out below, of 20 to 1 or less.

Preferably, at cryogenic temperatures, the conduit has a flexibility of 10 to 1 or less, that is the bend diameter of the conduit (the diameter of the cylinder about which the conduit is wrapped) may be less than 10 times the diameter of the conduit. Most preferably, the conduit has a flexibility of 5 to 1 or less.

The provision of a conduit with a wall having such a flexibility, made possible in part by the presence of a wall portion of porous material, increases the ease and convenience of use of the conduit.

Aspects of the invention relate to a flexible cryogenic fluid transfer conduit comprising a wall formed of a first portion of porous polymeric material and a second portion of impermeable material, the conduit being capable of withstanding an internal pressure of at least 0.5 psi at cryogenic temperatures. In certain embodiments of the invention, the conduit may withstand an internal pressure of 10 bar or greater.

The combination of flexibility and ability to retain pressurised cryogenic fluid overcomes many disadvantages associated with prior art cryogenic fluid transfer tubes, which tend to be relatively inflexible and brittle at cryogenic temperatures.

Preferably, a plurality of layers of material are superimposed on each other to provide a multi-layered composite material possessing a spiral-shaped cross-section, formed from one or more sheets of film. The film layers may be wrapped about the longitudinal axis of a mandrel. The film may be circumferentially wrapped such that the film width becomes the length of the conduit. Alternatively, long length conduits or tubes may be constructed by helically wrapping film. Helical wrapping in two directions may impart different properties to the tubes. In tubes formed of PTFE, the layers are bonded together by restraining the ends of the tube on the mandrel and then subjecting the assembly to temperatures above the crystalline melt point of PTFE. The cooled tube is then removed from the mandrel.

For the purposes of the present invention, the terms “porous”, and “non-porous” or “impermeable”, are defined as follows. A porous material contains open cell pore spaces that allow detectable passage of gaseous fluid across the material (e.g. as detected by a 280 Combo Analyser supplied by David Bishop Instruments, Heathfield, East Sussex, UK). A non-porous or impermeable material does not contain continuous void spaces across the material thereby limiting the passage of any substantial amount of fluid across the material.

PTFE-based articles of embodiments of the present invention are also preferred because of the low thermal conductivity of PTFE, which is about 0.232 Watts/mK. Porous articles of PTFE exhibit even lower thermal conductivity. The use of low thermal conductivity materials may result in safer articles with regard to issues such as potential for cold burns. Cryogenic fluid systems will benefit from lower thermal energy ingress and resulting reduction in gas generation within the fluid transport lines. PTFE additionally has a low heat capacity, namely 1047 kJ/kgK.

The choice of precursor ePTFE film material is a function of the desired number of layers in the final tube and tube wall thickness.

The conduit may incorporate convolutions or corrugations to enhance its bending and flex endurance characteristics. Reinforcement members may be incorporated helically, circumferentially, longitudinally or by combinations thereof to enhance conduit characteristics. The reinforcement members may be placed within or on the exterior surface of the tubular article. They may enhance the bending characteristics and flexural durability of the tube. Externally applied reinforcement in the form of rings or helically applied beading or filament or other configurations or materials may be incorporated into the inner tube construction in order to provide kink and/or compression resistance to the article. The reinforcement materials may include, but are not limited to, fluoropolymers (such as PTFE, ePTFE, fluorinated ethylene propylene (FEP), etc.), metals, or other suitable materials.

The non-porous or impermeable layer or portion of the conduit wall is preferably constructed from a polymer, particularly a fluoropolymer such as PTFE or FEP. These materials are reasonably durable and flexible at cryogenic temperatures, though not as flexible as porous ePTFE.

### BRIEF DESCRIPTION OF THE DRAWINGS

These and other aspects of the present invention will now be described, by way of example, with reference to the accompanying drawings, in which:

FIG. 1 is a part cut away perspective view of a tube in accordance with an embodiment of the present invention;

FIGS. 2-6 are enlarged views of the section of tube wall as exposed by the cut away in FIG. 1, and illustrating various alternative tube wall constructions;

FIG. 7 is a perspective view of a step in the creation of a tube in accordance with an embodiment of an aspect of the present invention; and

FIG. 8 is a transverse sectional view of the tube form produced by the step of FIG. 7.

### DETAILED DESCRIPTION OF PREFERRED EMBODIMENTS

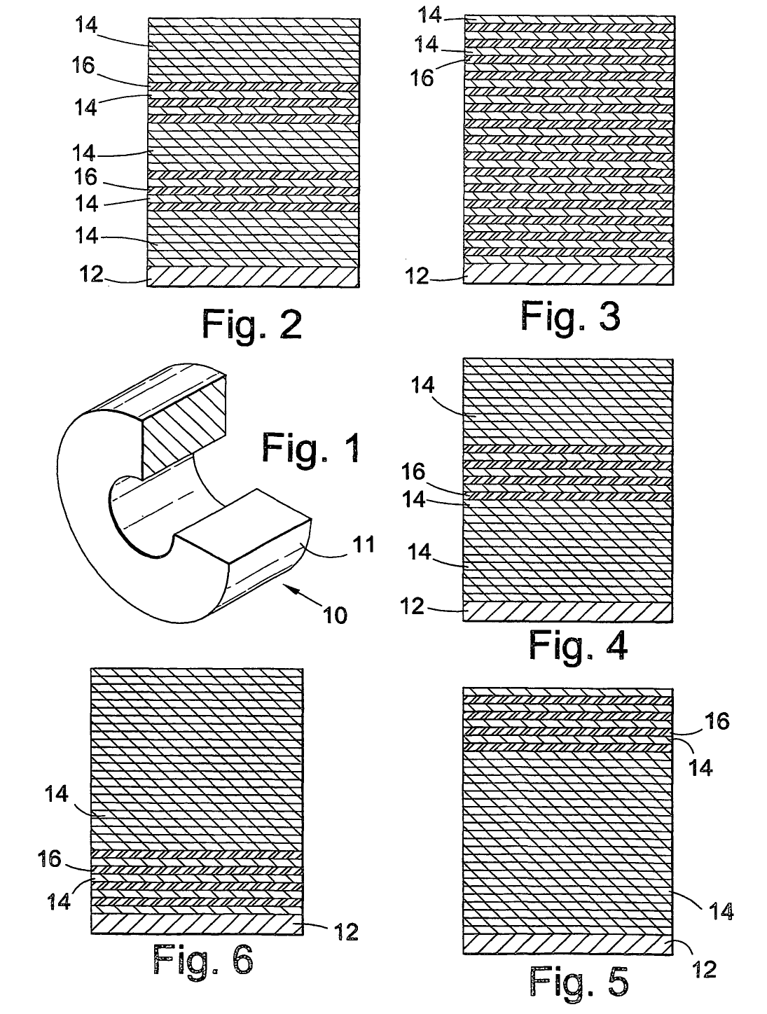

Reference is first made to FIG. 1 of the drawings, which is a part cut away perspective view of a conduit in the form of a tube 10 in accordance with an embodiment of the present invention. The tube wall 11 is formed of layers of porous and non-porous or impermeable sheet material, as described below with reference to FIG. 2 to 6 of the drawings, which are enlarged views of the section of tube wall as exposed by the cut-away in FIG. 1, and illustrate various alternative tube wall constructions.

FIG. 2 illustrates a tube wall formed with a inner base tube 12 of expanded PTFE (ePTFE), overwrapped with six layers of ePTFE sheet film 14, followed by three wraps of ePTFE film 14 in parallel with FEP film 16, followed by five wraps of ePTFE film 14, followed by another by three wraps of ePTFE film 14 in parallel with FEP film 16, and finally followed by eight wraps of ePTFE film 14.

FIG. 3 illustrates a tube wall formed with a inner base tube 12 of expanded PTFE (ePTFE), overwrapped fifteen wraps of ePTFE film 14 in parallel with FEP film 16, followed by a single wrap of ePTFE film 14.

FIG. 4 illustrates a tube wall formed with a inner base tube 12 of expanded PTFE (ePTFE), overwrapped with eleven layers of ePTFE sheet film 14, followed by four wraps of ePTFE film 14 in parallel with FEP film 16, followed by eleven wraps of ePTFE film 14.

FIG. 5 illustrates a tube wall formed with a inner base tube 12 of expanded PTFE (ePTFE), overwrapped with twenty one layers of ePTFE sheet film 14, followed by four wraps of ePTFE film 14 in parallel with FEP film 16, followed by a single wrap of ePTFE film 14.

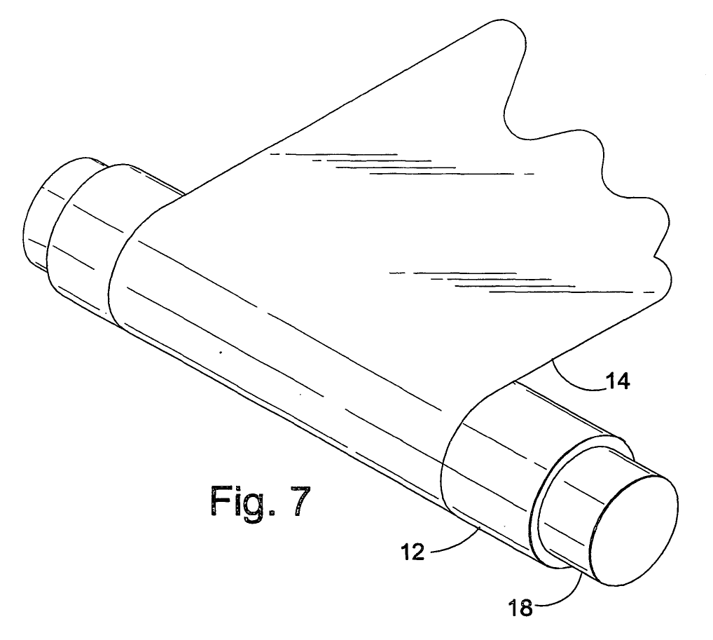

FIG. 6 illustrates a tube wall formed with a inner base tube 12 of expanded PTFE (ePTFE), overwrapped with four wraps of ePTFE film 14 in parallel with FEP film 16, followed by twenty two wraps of ePTFE film 14.

An example of a tube in accordance with an aspect of an embodiment of the present invention will now be described, following a brief description of a number or the test methods utilised to determine properties of the materials utilised in the example.

### Bubble Point and Thickness Testing for Films

Bubble point of films is measured according to the procedures of ASTM F31 6-86. The film is wetted with isopropanol (IPA).

Film thickness is measured with a snap gauge (such as Model 2804-10 Snap Gauge available from Mitutoyo, Japan). Gurley Air Permeability Testing for the Film

The resistance of samples to airflow is measured by a Gurley densimeter, such as that manufactured by W. & L. E. Gurley & Sons, in accordance with conventional measurement procedures, such as those described in ASTM Test Method D726-58. The results are reported in terms of Gurley Number, or Gurley-Seconds, which is the time in seconds for 100 cubic centimetres of air to pass through 1 square inch of a test sample at a pressure drop of 4.88 inches of water.

### Isopropanol Bubble Point, Gurley Air Permeability and Tube Dimension Measurement Testing for the Tubes

The tubes are mounted to barbed luer fittings and secured with clamps and tested intact.

The isopropanol (IPA) bubble points (IBP) are tested by first soaking the tubing fixtures in IPA for approximately six hours under vacuum, then removing the tubing from the IPA and connecting the tubing to an air pressure source and re-immersing the tube in IPA in a transparent container. Air pressure is then manually increased at a slow rate until the first steady stream of bubbles is detected. The corresponding pressure is recorded as the IBP.

The air permeability measurement is determined using a Gurley Densometer (such as a Model 4110 densometer from W. & L. E. Gurley, Troy, N.Y.) fitted with an adapter plate that allows the testing of a length of tubing. The average internal surface area is calculated from the measurements utilising a Ram Optical Instrument (such as a Model OMIS II 6×12 from Ram Optical Instrumentation Inc., 15192 Triton Lane, Huntington Beach, Calif. The Gurley Densometer measures the time it takes for 100 cc of air to pass through the wall of the tube under 4.88 inches (12.40 cm) of water head of pressure.

The wall thickness and outer diameter of the tube are measured using the same OMIS II optical system.

### EXAMPLE

An example will now be described, producing a tube wall construction similar to that as illustrated in FIG. 4 of the drawings.

A thin longitudinally expanded PTFE base tube 12 possessing a wall thickness of 0.0051″ (0.131 mm), an inner diameter of 0.157″ (4.0 mm), Gurley number of 0.9 sec, and an IBP of 0.79 psi (0.0055 MPa) is obtained. Referring to FIG. 7, this tube 12 is snugly slipped over 0.250″ (6.35 mm) diameter mandrel 18.

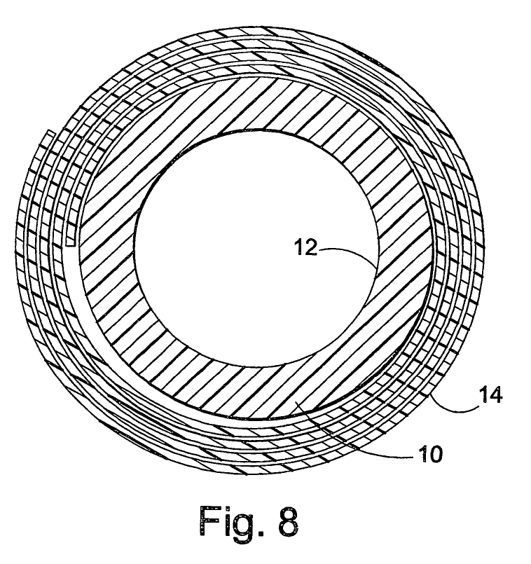

Expanded PTFE film 14 is obtained possessing a thickness of 0.0034″, (0.086 mm), a Gurley number of 37.1 seconds, and an isopropanol bubble point of 50.3 psi (0.342 MPa). All measurements are made in accordance with the procedures previously described, unless otherwise indicated. This ePTFE film 14 is then circumferentially wrapped over the thin ePTFE base tube 12 such that the width of the film 14 becomes the length of the resultant tube as depicted in FIG. 8. Ten layers of film 14 are wrapped around the base tube.

A sheet of continuous FEP film 16 is now placed on top of more expanded ePTFE film 14. This FEP 16 is 0.0005″ (0.0127 mm) in thickness and of sufficient width and length to provide four complete circumferential wraps of the tube in parallel with the ePTFE membrane 14, similar to the arrangement as shown in FIG. 4. A further eleven layers of membrane 14 are then wrapped onto the tube to provide a total of twenty-five layers of ePTFE membrane 14 with four layers of continuous FEP 16 placed between layers eleven to fifteen of the construction.

The cross-sectional geometry of the layered tube construction is spiral-shaped, as indicated in FIG. 8.

The ends of the layered film and base tube construction are restrained by restraining wires means to prevent shrinkage in the longitudinal direction of the construction (the longitudinal axis of the mandrel) during subsequent heat treatment. The restrained tube construction is placed in an air oven at 375° C. for ten minutes in order to bond the ePTFE and FEP layers and impart dimensional stability to the tube. The tube is allowed to cool before the wire restraints are removed and the tube is removed over the end of the mandrel.

The finished tube length is about 25.7″ (0.653 m), outside diameter is 0.306″ (7.772 mm) and internal diameter 0.250″ (6.35 mm). The inventive impermeable transfer tube is attached to the liquid nitrogen supply and tested in accordance with the bending diameter and cryogenic fluid permeation test as described below.

The tube example described here displayed no signs of nitrogen permeation either before or after the bending diameter test while being pressurised with 45 psig of nitrogen fluids.

### Liquid Cryogenic Fluid Permeation Test

A liquid nitrogen fluid permeation test was developed to detect whether liquid nitrogen permeates through a cryogen tube wall at a given pressure.

A vacuum insulated test Dewar is obtained from A S Scientific Ltd (Abington, Oxford, UK). The Dewar has a holding capacity of ten litres of liquid nitrogen and is fitted with a burst disc (Elfab Hughes) as over pressure protection. Discharge and vent valves are ½″ bore ball valves supplied by A S Scientific. Immediately after the test discharge valve a ½″ BSP to ¼″ Swagelok compression fitting (supplied by South of Scotland Valve and Fitting Company, Irvine, Scotland) was fitted. Each end of the test sample had a piece of stainless steel tube inserted (0.95″ long×0.25″ od×0.215″ id) to half its length and fastened there by means of an Oetiker Crimp fastening by Oetiker, Inc, Livingston, N.J., U.S.A. The remaining exposed insert length allowing for the attachment of the Swagelok compression fitting. The test tube has another stainless steel tube inserted into the other end to which was attached, by means of another Oetiker Crimp and Swagelok compression assembly, a piston control valve (Swagelok, part number SS-1GS4). From the exit of this valve was fitted 6 m of polyethylene tube (0.16″ bore, 0.248″ outside diameter). This tube was used to lead the exhaust gas from the test assembly away from the vicinity of the gas analyser (to another room).

Liquid nitrogen is added to the lumen of tested tubes and pressurised to a predetermined pressure, selected on the basis of the intended application of the tubes. The tube wall is probed with a 1/16″ (1.6 mm) bore silicone tube connected to a gas analyser (model 280 combo, David Bishop Instruments, Heathfield, East Sussex, England). The tube was used to probe along the length of the tube wall to measure the oxygen content of the air at the tube wall. Typically four or five measurements would be taken over a period of about one minute. If there is a drop in oxygen content of the air sampled then nitrogen has permeated through the tube wall.

Following a bending diameter test (described below) a further examination of the tube wall is carried out to determine if flexure of the tube wall has resulted in damage to the wall internal structure thus allowing permeation to start.

Whereas this test was developed specifically for testing tubes, the same principles may be applied to create a test for the examination of the properties of other shapes of materials. The important elements of the test include: controlled flexure or bending of the tube and ability to measure the pressure required to force a mass of liquid nitrogen to permeate the tube wall.

### Bending Diameter Test

Five minutes after the opening of the Dewar valve, which initiates the cryogenic fluid permeation test, the transfer tube is wrapped around the outside of a hollow non-metallic, typically polymeric (for example, nylon) cylinder to determine the diameter at which the tube wall will rupture or allow permeation of fluids. Liquid nitrogen continues to flow through the tubes during the test. The tube is examined for evidence of kinking. “Kinking” is defined as a crease in one or more of the tubular components. Following a bending test the tube is again tested to assess for initiation of permeation of cryogen. The tube is also visually examined for evidence of fracture, to determine if the wrapping had compromised the ability of the tube to hold liquid.

It will of course be apparent to those of skill in the art that the above described embodiments and example are merely exemplary of the present invention and that various modifications and improvements may be made thereto without departing from the scope of the present invention.

1. A method of transferring a cryogenic fluid, the method comprising passing a cryogenic fluid through a flexible conduit having a wall formed of a first layer of a porous polymeric material and a second layer formed of an impermeable material.

2. The method of claim 1, wherein the first layer is selected to have a heat capacity of less than 2.251×10⁶ kJ/m³K.

3. The method of claim 2, wherein the first layer is selected to have a heat capacity of less than 1.75×10⁶ kJ/m³K.

4. The method of claim 3, wherein the first layer is selected to have a heat capacity of less than 1.25×10⁶ kJ/m³K.

5. The method of claim 4, wherein the first layer is selected to have a heat capacity of less than 0.75×10⁶ kJ/m³K.

6. The method of claim 5, wherein the first layer is selected to have a heat capacity of less than 0.5×10⁶ kJ/m³K.

7. The method of any of the preceding claims, wherein the first layer is selected to have a thermal conductivity of less than about 0.232 Watts/mK.

8. The method of claim 7, wherein the first layer is selected to have a thermal conductivity of less than about 0.186 Watts/mK.

9. The method of claim 8, wherein the first layer is selected to have a thermal conductivity of less than about 0.139 Watts/mK.

10. The method of claim 9, wherein the first layer is selected to have a thermal conductivity of less than about 0.113 Watts/mK.

11. The method of claim 10, wherein the first layer is selected to have a thermal conductivity of less than about 0.066 Watts/mK.

12. The method of any of the preceding claims, wherein the conduit is selected to have a heat capacity of less than 2.251×10⁶ kJ/m³K.

13. The method of claim 12, wherein the conduit is selected to have a heat capacity of less than 1.75×10⁶ kJ/m³K.

14. The method of claim 13, wherein the conduit is selected to have a heat capacity of less than 1.25×10⁶ kJ/m³K.

15. The method of claim 14, wherein the conduit is selected to have a heat capacity of less than 0.75×10⁶ kJ/m³K.

16. The method of claim 15, wherein the conduit is selected to have a heat capacity of less than 0.5×10⁶ kJ/m³K.

17. The method of any of the preceding claims, wherein the conduit is selected to have a thermal conductivity of less than about 0.232 Watts/mK.

18. The method of claim 17, wherein the conduit is selected to have a thermal conductivity of less than about 0.186 Watts/mK.

19. The method of claim 18, wherein the conduit is selected to have a thermal conductivity of less than about 0.139 Watts/mK.

20. The method of claim 19, wherein the conduit is selected to have a thermal conductivity of less than about 0.113 Watts/mK.

21. The method of claim 20, wherein the conduit is selected to have a thermal conductivity of less than about 0.066 Watts/mK.

22. A method of transferring a cryogenic fluid between two relatively movable locations, the method comprising passing a cryogenic fluid through a flexible conduit having a wall formed of a first layer of a porous polymeric material and a second layer formed of an impermeable material.

23. A method of storing a cryogenic fluid, the method comprising placing a cryogenic fluid in a container having a wall formed of a first layer of a porous polymeric material and a second layer formed of an impermeable material.

24. A method of insulating a cryogenic fluid container having a wall formed of a first layer of an impermeable material, the method comprising providing the wall with a second layer of a porous polymeric material.

25. The method of claim 24, wherein the second layer is provided internally of the first layer.

26. The method of claim 24, wherein the second layer is provided externally of the first layer.

27. A flexible cryogenic fluid transfer conduit comprising a wall formed of a first portion of a porous polymeric material and a second portion comprising a plurality of layers of coiled impermeable sheet.

28. A flexible cryogenic fluid transfer conduit comprising a wall formed of a inner first portion comprising a plurality of layers of porous polymeric sheet and an outer second portion comprising a plurality of layers of impermeable sheet, the impermeable sheet being of smaller thickness than the porous polymeric sheet.

29. A flexible cryogenic fluid transfer conduit comprising a wall formed of a first portion of porous polymeric material and a second portion of impermeable material, the conduit having a diameter of less than 25.4 mm.

30. A flexible cryogenic fluid transfer conduit comprising a wall formed of a first portion of porous polymeric material and a second portion of impermeable sheet material having an axially extending edge.

31. A flexible cryogenic fluid transfer conduit comprising a wall formed of a first portion of a seamless porous polymeric tube and a second portion of impermeable material.

32. A flexible cryogenic fluid transfer conduit comprising a wall formed of a first portion of porous polymeric material and a second portion of impermeable material, at cryogenic temperatures the conduit having a flexibility, as determined by the bend diameter test set out above, of 20 to 1 or less.

33. The conduit of claim 32, wherein, at cryogenic temperatures, the conduit has a flexibility of 10 to 1 or less, that is the bend diameter of the conduit may be less than 10 times the diameter of the conduit.

34. The conduit of claim 33, wherein, at cryogenic temperatures, the conduit has a flexibility of 5 to 1 or less, that is the bend diameter of the conduit may be less than 5 times the diameter of the conduit.

35. A flexible cryogenic fluid transfer conduit comprising a wall formed of a first portion of porous polymeric material and a second portion of impermeable material, the conduit having a heat capacity of less than 2.251×10⁶ kJ/m³K.

36. A flexible cryogenic fluid transfer conduit comprising a wall formed of a first portion of porous polymeric material and a second portion of impermeable material, the conduit having a thermal conductivity of less than about 0.232 Watts/mK.

37. A flexible cryogenic fluid transfer conduit comprising a wall formed of a first portion of porous polymeric material and a second portion of impermeable material, the conduit being capable of withstanding an internal pressure of at least 0.5 psi.

38. A flexible cryogenic fluid transfer conduit comprising a wall formed of a first portion of a porous polymeric material and a second portion comprising a smooth-walled layer of impermeable material.

39. The conduit of any of claims 27 to 38, wherein the porous polymeric material comprises expanded PTFE.

40. The conduit of any of claims 27 to 39, wherein the impermeable material comprises a fluoropolyer.

41. The conduit of claim 40, wherein the impermeable material comprises PTFE.

42. The conduit of claim 40, wherein the impermeable material comprises a copolymer of hexafluoropropylene and tetrafluoroethylene.

43. The conduit of claim 40, wherein the impermeable material comprises a copolymer of tetrafluoroethylene and perfluoropropyl vinyl ether (PFA).
